(19) United States
(12) Patent Application Publication
(10) Pub. No.: US 2015/0375449 A1
(43) Pub. Date: Dec. 31, 2015

(54) MEDIA-FREE, TEMPERATURE-ASSISTED ADHESIVE CONNECTION METHOD

(71) Applicant: PRINTEC GmbH, Friedrichroda OT Ernstroda (DE)

(72) Inventor: Thomas Streichardt, Warendorf (DE)

(21) Appl. No.: 14/767,150

(22) PCT Filed: Feb. 11, 2014
(86) PCT No.: PCT/EP2014/052601

§ 371 Date: Aug. 11, 2015

(30) Foreign Application Priority Data
Feb. 12, 2013 (DE) 10 2013 002 432.3
Mar. 28, 2013 (DE) 10 2013 005 394.3

(51) Int. Cl. B29C 65/00; B32B 37/04; B29C 65/02; B32B 27/08; B32B 27/32; B32B 21/08; B32B 38/00; B32B 37/10

(52) U.S. Cl. CPC B29C 66/71; B32B 38/0012; B32B 38/0004; B32B 37/04; B32B 37/10; B32B 27/08; B32B 27/32; B32B 21/08; B29C 65/02; B29C 66/7487; B29C 66/91; B32B 2250/03; B32B 2323/10; B32B 2317/16; B32B 2038/0016; B29L 2031/44

(57) ABSTRACT

The invention relates to a media-free, temperature-assisted adhesive connection method for connecting polypropylene (PP)-based molded parts, profiled sections, strips, and/or films in order to form a mechanically machinable multilayer arrangement on a main part with a different geometric design. According to the invention, a first molded part, profiled section, strip, or film layer (2) is first applied onto the main part (1), wherein energy is locally applied to the layer face pointing towards the main part until the lower face melts and is then immediately fixed to the main part (1) under the effect of pressure. A second layer (2) is then applied onto the main part which has been provided with the first layer in a process in which solely the lower face of the second layer is melted by locally applying energy, the second layer is immediately brought into contact with the surface of the first layer, and the first and the second layer are connected using pressure. A third layer can subsequently be applied onto the main part which has been provided with the second layer in a process in which solely the lower face of the third layer is melted by locally applying energy, the third layer is immediately brought into contact with the surface of the second layer, and the second and the third layer are connected using pressure. The aforementioned sequence of steps is repeated with a fourth to an n-th layer until the desired total layer thickness of the multilayer arrangement is reached.

The invention relates to a media-free, temperature-assisted adhesive bonding method for polypropylene (PP)-based molded parts, sections, strips and/or films for forming a mechanically machinable multilayer arrangement on a base body of a different geometrical shape.

Polypropylene (PP) plastics have an extremely diverse range of applications and are used for example in vehicle interiors, as plastic housings, for safety devices, electrical equipment coatings, construction pipes and fittings, as well as in the ventilation and air-conditioning field.

There are known methods of materially bonding polypropylene by ultrasonic or laser welding using a heated tool in welding processes. In principle, the respective welding zones are brought into a plasticized state in the above-cited welding methods by an external application of heat, whereby the bonding occurs following the heating once contact is made. In order to effect the welding, the contact points of the plastic parts need to be heated until the melting temperature of said contact points is reached. The contact points are then brought together and pressed against each other until they have fully cooled.

In ultrasonic welding, the energy required for the welding process is generated by ultrasonic vibrations. The ultrasonic vibrations induce the molecular motion of the polypropylene material at the respective points, resulting in friction, which in turn leads to melting the plastic.

In laser beam welding, the laser beam is focused by means of the appropriate optics, whereby the optics focus on the abutting ends of the items to be welded. In laser beam welding, the optics generate a very high concentration of energy onto a minimum of space within a short period of time, which results in the desired fusing.

In order to weld plastics with a laser beam, they need to be thermoplastic. Plastics are usually joined together in an overlapping process using different welding partners. An upper welding partner is usually selected such that the laser beam can pass through it substantially unhindered and thereby only negligibly heats said welding partner. The welding partner below it, however, absorbs the laser beam; i.e. absorbs energy, reaching the softening temperature of the welding partner. The weld results from the coalescing of the heated welding partners.

Plasticization of plastics for the purpose of welding is also possible by means of targeted application of hot air, with variable temperatures as well as volumes of air being supplied in conjunction hereto.

A method for bonding plastic workpieces is known from DE 10 2004 030 619 A1. Same initially indicates that a respective absorption layer 1 nm to 100 nm thick, preferentially 5 nm to 15 nm thick, needs to be applied to the workpieces to be joined. The workpieces are then subsequently pressed together at a defined contact pressure, whereby the respective absorption layers are to be disposed between the two workpieces.

One of the absorption layers is then exposed to a first laser, the beam of which is focused onto said absorption layer. The output of this laser is selected so as to heat the absorption layer and thereby join together the two workpieces contiguous to the absorption layer.

When a plurality of polymer workpieces are to be bonded together, the above-cited method step is repeated with additional absorption layers onto which a laser beam is in each case focused. In one particular embodiment, one workpiece remains uncoated and the laser beam is directed onto the absorption layer through said workpiece. A second laser can structure the specially applied absorption layer by laser ablation in order to optimize the welding process.

Further known from the prior art is applying calendered or extruded polypropylene-based strips, sections or molded parts to furniture panels, particularly the edges of furniture panels, in order to ensure a visually attractive panel finish and at the same time protect the panel's processed wood material from environmental influences, particularly moisture. Such edging strips can both be materially bonded to the wood material by means of hot-melt adhesive as well as softened, plasticized or fused by laser radiation so that an adhesive bonding will result between the respective edging strip and furniture material upon the corresponding application of pressure and subsequent cooling.

It has been shown, however, that the thickness of the edging strip to be applied is extremely limited, particularly in the case of contoured furniture panels having narrow, i.e. small radii, because there is otherwise the danger of surface cracks forming or the edging strip separating in the radius area.

There is in many cases the desire to contour edging strips, particularly also for design reasons, as well as fix same to highly contoured panels having narrow radii, this not being possible according to the state of the prior art. Particularly in the case of special contouring, realized by subsequent machining processes, plastic edging strips need to have a minimum thickness which the relevant materials have been unable to achieve, particularly in respect of narrower installation radii.

Based on the foregoing, the task of the invention is thus that of specifying a further developed media-free, temperature-assisted adhesive bonding method for polypropylene-based molded parts, sections, strips and/or films for forming a mechanically machinable multilayer arrangement on a base body of a different geometrical shape which ensures a solid bond to the base body and is moreover suitable to be used in the case of base bodies having narrow contours and radii.

A further subtask of the invention consists of using one procedure for the actual bonding process which is able to be employed in the same way both with respect to the bond to the base body as well as in the forming of the successive layers so as to allow continuous processing without any time-consuming conversions.

The invention solves this task by a method in accordance with the teaching of claim 1, wherein the subclaims at the least constitute advantageous embodiments and further developments.

Further inventive is an edging strip based on the multilayer arrangement described herein which itself is manufactured in accordance with the inventive method.

Thus provided is a media-free, temperature-assisted adhesive bonding method for polypropylene (PP)-based molded parts, sections, strips and/or films for forming a mechanically machinable multilayer arrangement on a base body of a different geometrical shape.

According to the invention, in a first step a), a first molded part, section, strip or layer of film is applied to the base body by energy being locally applied to the emulsion side facing the base body until the underside melts and is immediately thereafter fused to the base body under the effect of pressure.

In step b) following next, a second layer is applied to the base body provided with the first layer, followed by an underside melting of exclusively the second layer by local application of energy as well as the second layer being immediately brought into contact with the surface of the first layer and the first layer bonding to the second layer under the application of pressure.

In step c), a third layer can be applied to the base body provided with the second layer, followed by an underside melting of exclusively the third layer by local application of energy as well as the third layer being immediately brought into contact with the surface of the second layer and the second and third layer bonding under the application of pressure.

According to the invention, step c) is repeated with a fourth to n-th layer until the total desired thickness of the multilayer arrangement is reached. The claims specify this as step d).

From the design perspective, the surface of the first to the (n1)-th layer can undergo treatment to increase its roughness prior to the second to n-th layer being applied. This treatment can be a plasma treatment, ion etching, sanding, a machining process or a selective microsphere treatment or the like.

In a further embodiment of the invention, the respective layer to be applied is continuously applied, e.g. by the roll, melted on the underside and bonded to the layer beneath it.

The base body can consist of a polypropylene material, a material containing polypropylene, a processed wood material or a composite material.

A roller or a group of rollers can be used according to the invention to generate the pressure, the movement of same following the respective contour of the base body. In the case of particularly complex base body structures, a hydraulically deformable body can be used in place of a roller to create the necessary pressure or pressurization is provided by means of targeted application of compressed air. Said compressed air can at the same time be used to regulate the cooling of the respective layer.

The respective thicknesses of the individual layers are in the range of ≦4 mm, wherein a total layer thickness can be in the range of from 1 cm to several cm.

In one preferential embodiment of the invention, at least one of the layers is colored, structured and/or imprinted.

In a further preferential embodiment of the invention, the multilayer arrangement created overlaps or projects beyond given sections of the base body.

In one preferential embodiment of the invention, the base body can exhibit the form of a panel having peripheral, even contoured narrow ends, whereby the layer sequence is successively applied on at least one of the narrow ends.

Alternatively, the base body can also consist of one lightweight panel comprising an upper panel and a lower panel as well as an intermediate structure, e.g. in honeycomb form, as well as a lateral support edge. The layer sequence can then be successively deposited in the edge region both on the exposed areas of the upper and lower panels as well as the support edge connecting all the elements.

The respective underside melting process of the relevant layer can be pyrometrically monitored and regulated accordingly.

In a further development of the invention, the underside melting occurs immediately prior to the respective layers being brought into contact so as to ensure a desirable thermal transfer of energy from the melted layer to the layer beneath it for optimal bonding.

The completed multilayer arrangement can be formed into its own separate molded body by milling, notching, sanding or other such mechanical processing.

Said molded body can comprise for example a handle element, a latching pin, a latching groove, a beveled surface, a decorative contour, a tooth configuration or the like.

The invention also provides for further developing the multilayer arrangement into an ornamental element in the case of differently colored layers by selectively ablating regions of said layers.

One inventive use of the method occurs when edging strips are applied to processed wood material, whereby the multilayer arrangement is used instead of the usual edging strips.

According to the invention, a multilayer arrangement is produced according to the method as described by the invention, particularly a furniture panel having an edging strip produced in accordance with the inventive method.

According to the invention, this aspect specifies an edging strip based on the multilayer arrangement described herein, produced pursuant to a method as described above.

A furniture panel having such an edging strip is also further described, wherein the edging strip is partially or fully materially bonded to the edge of the furniture panel. The material of the furniture panel preferably consists of wood, processed wood material, wood substitute material, plastic, metal, glass, stone, ceramic or a combination thereof.

The following will reference an embodiment as well as figures in describing the invention in greater detail.

The figures thereby show:

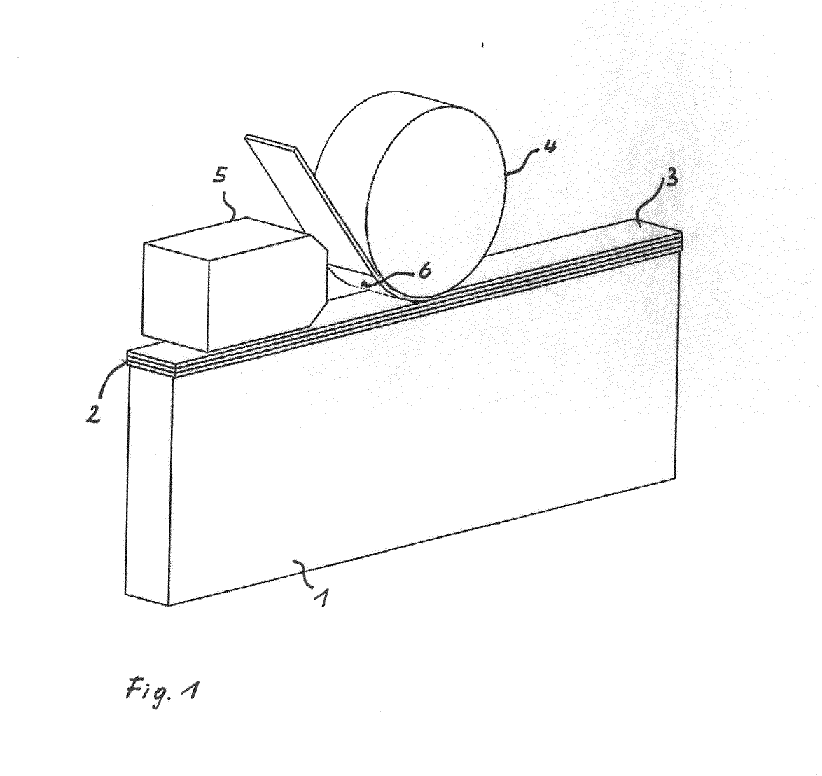

FIG. 1 a schematic diagram in respect of the adhesive bonding method using the example of a multilayer arrangement to be created on a longitudinal narrow end of a panel;

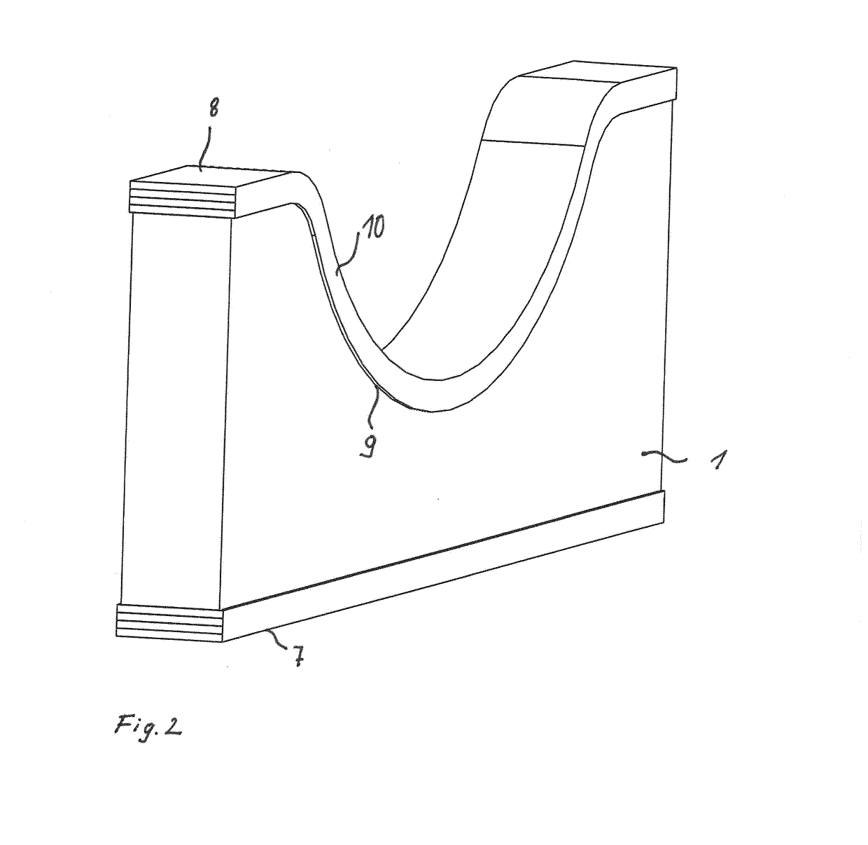

FIG. 2 the forming of the multilayer arrangement on a base body having a curved contour prior to mechanical treatment;

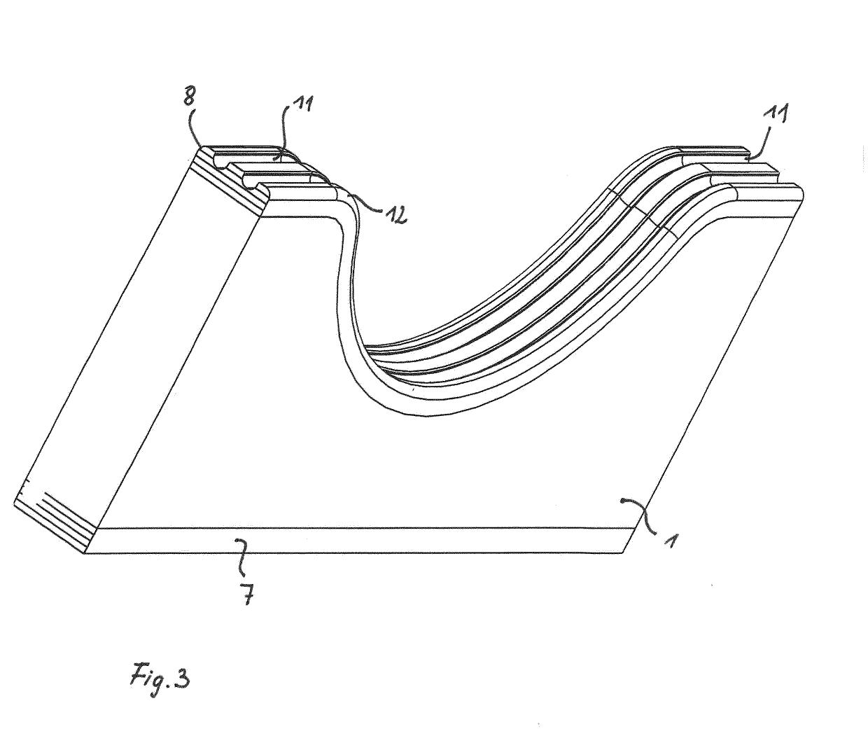

FIG. 3 a depiction similar to that of FIG. 2, although resulting from subsequently treating the multilayer arrangement in a milling procedure to obtain a three-dimensional narrow end configuration;

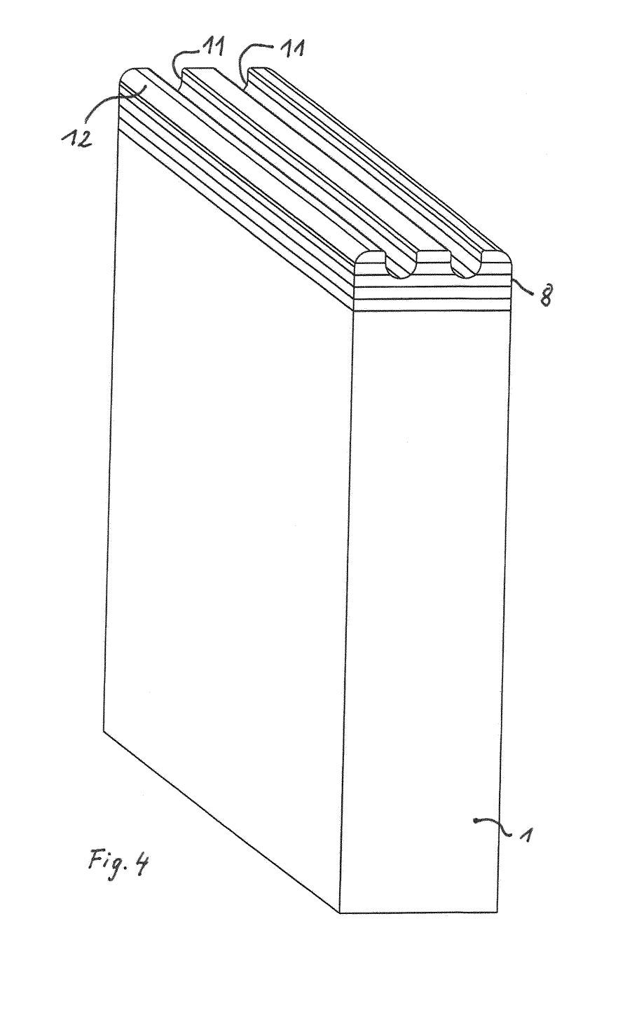

FIG. 4 a perspective representation of a base body having a multilayer arrangement in a structure comprising milled grooves;

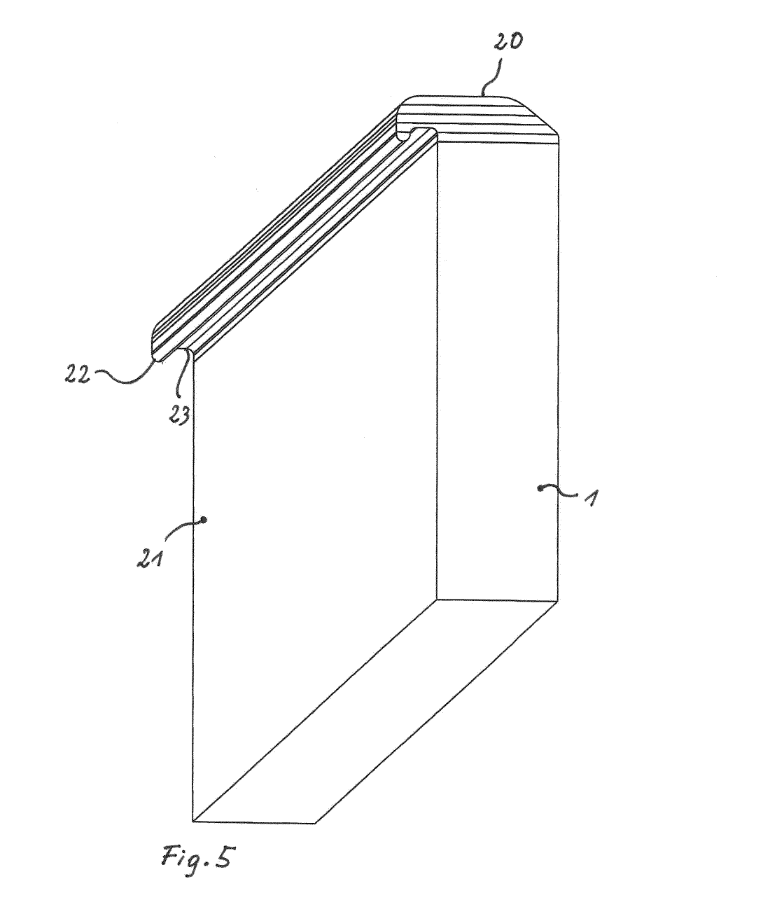

FIG. 5 one embodiment of a base body having a multilayer arrangement projecting laterally over an upper edge which is given the form of a gripping edge in subsequent milling;

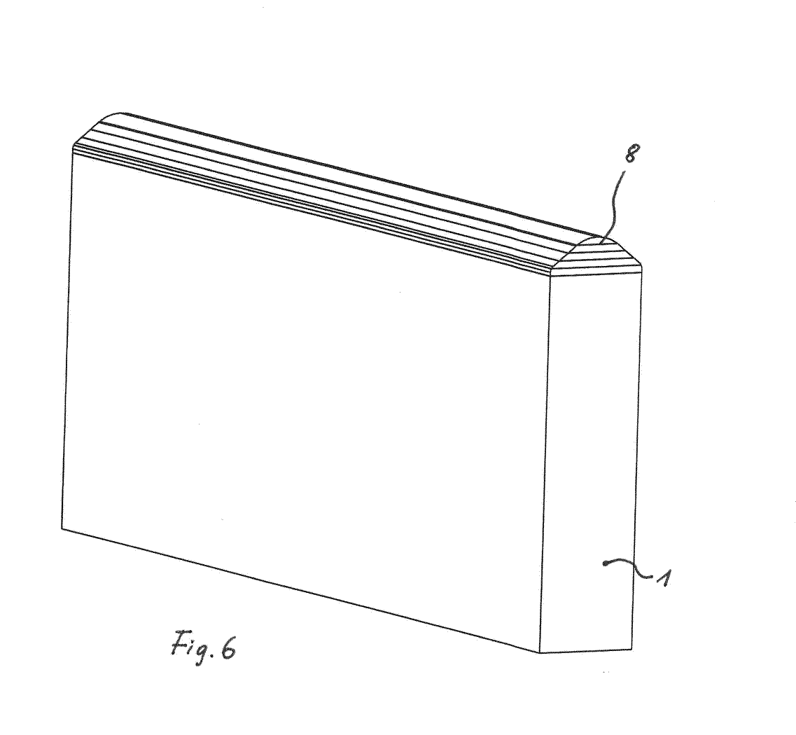

FIG. 6 a perspective representation of a base body having a multilayer arrangement which has been subjected to mechanical treatment after being deposited such that the individual layers are visible, which in particular results in a special ornamental effect in the case of differently colored layers, and

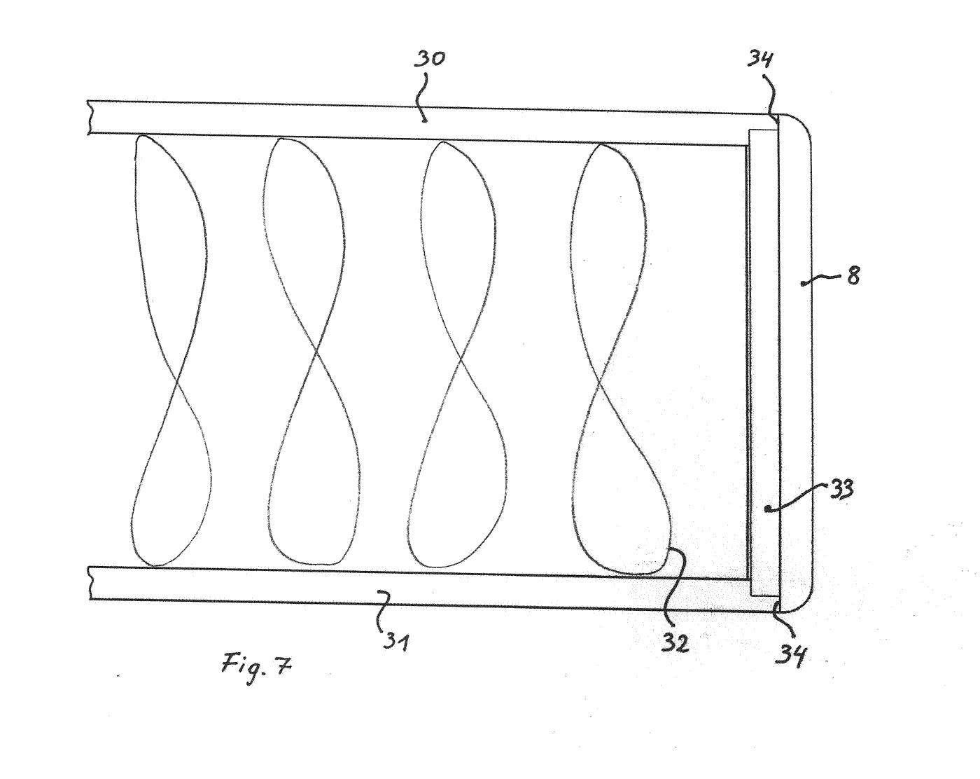

FIG. 7 a sectional view of a composite panel having an upper panel and a lower panel as well as a layered structure therebetween along with a supporting body and multilayer arrangement in the form of a lateral edge cover.

The method according to the invention forms a multilayer arrangement based on a composite sequence of layers of PP material, produced by adhesive bonding not requiring adhesive pretreatment. Strips or sections can be fully or also partially bonded in multiple successive layers in order to for example obtain a staggered structure in the sense of a staircase configuration.

The PP-based strips or sections, or molded parts respectively, which are thus bonded or quasi-fused can be mechanically treated, e.g. machined, so as to subsequently form a two-dimensional or three-dimensional contour.

The multilayer arrangement can make use of colored, particularly multi-colored strips or contours, whereby the respective first strip or contour layer is applied to for example a wood or polymer material, which can be realized using prior art methods, but also analogously to the inventive method presented herein.

In one embodiment variant, a plurality of successive, quasi-fused strips each having a thickness of approximately 2 mm are realized on the narrow edges of contoured panels having small radii of ≦20 mm radius. In conjunction hereto, thick edges can also be realized on contoured panels having very small radii, which is not possible with conventional edging strips. In one embodiment shown as a result in the sectional view of FIG. 7, the multilayer arrangement with desired surface finish can also be applied to a lightweight panel having a PP-based support edge. Common to all the embodiments is that only one joining area is in each case thermally activated; i.e. melted on the underside. Said melting can be effected by laser, plasma treatment, hot air and/or ultrasound.

In accordance with FIG. 1, the method starts from an e.g. panel-shaped base body 1, the upper narrow end of which is to be provided with a multilayer arrangement based on a plurality of PP layers. In the example shown in FIG. 1, three layers 2 have already been deposited and a fourth layer 3 is now to be applied. The fourth layer 3 is supplied e.g. from a roll (not shown) and brought into contact with the layer beneath it by a pressure roller 4.

The underside of layer 3 is melted by means of power generating mechanism 5. The melted area is identified by reference numeral 6.

Immediately after the melting, the melted side is brought into contact with the layer underneath it under the application of pressure by means of roller 4 and a relative motion to the base body 1 follows between the power generating mechanism 5 and roller 4 components.

FIG. 2 shows the example embodiment of a base body 1 having a multilayer arrangement 7, 8 on the lower side as well as the upper side.

The multilayer arrangement 8 on the upper side follows an arcuate contour 9 of the base body.

The likewise arcuate contour 10 of the multilayer arrangement can be of grooved structure, for example by being milled, as the result depicted in FIG. 3. The grooved structure obtained is symbolized by reference numeral 11.

In addition to the grooved structure, a rounded edge 12 can also be obtained in the edge region by the appropriate milling.

The perspective representation of FIG. 4 shows a similar structure able to be obtained by milling.

In accordance with the perspective representation of FIG. 5, a panel-shaped base body 1 is provided with a multilayer arrangement 20 extending laterally over the surface 21 of the base body 1.

The lateral projection is then machine-milled and in such a way as to produce a handle edge 22 with recessed grip 23.

The panel-shaped base body 1 according to FIG. 6 likewise has a multilayer arrangement 8 on a narrow end mechanically machined into an arcuate shape. Such mechanical processing can selectively expose layer sections which results, particularly in the case of multicolored layers, in an attractive ornamental design element.

FIG. 7 shows a partially sectional view through a lightweight panel having an upper panel 30 and a lower panel 31 as well as a lightweight honeycomb structure 32 therebetween.

A support edge 33 is employed on one face end. This support edge can itself be a layer of the multilayer structure. The inventive multilayer arrangement 8 covers the support edge 33, whereby the multilayer arrangement 8 is not only in contact with the support edge 33 over a large surface area but also with the corresponding area 34 of the upper panel 30/lower panel 31 in order to obtain a solid, inherently stable and ornamentally attractive bond.

What is claimed is:

1. A media-free, temperature-assisted adhesive bonding method for polypropylene (PP)-based molded parts, sections, strips and/or films for forming a mechanically machinable multilayer arrangement on a base body of a different geometrical shape, the method comprising:
applying a first molded part, section, strip or layer of film to the base body by locally applying energy to an emulsion side facing the base body until the underside melts and fusing it immediately thereafter to the base body under the effect of pressure;
applying a second layer to the base body provided with the first layer, melting exclusively the underside of the second layer by local application of energy as well as immediately bringing the second layer into contact with the surface of the first layer and bonding the first layer to the second layer under the application of pressure;
selectively applying a third layer to the base body provided with the second layer, melting exclusively the underside of the third layer by local application of energy as well as immediately bringing the third layer into contact with the surface of the second layer and bonding the second layer to the third layer under the application of pressure; and
repeating selective application of at least one additional layer until reaching the total desired thickness of the multilayer arrangement.

2. The method according to claim 1, wherein
the PP material composition is based on a free-flowing polypropylene homopolymer having a melt flow index of 0.5 to 200 g/10 min and provided with a coupling reagent, based on maleic anhydride, silane and further additives, to increase energy absorption as well as processing additives and pigments for coloring.

3. The method according to claim 1, wherein
the surface of the first to the (n1)-th layer undergoes treatment to increase its roughness prior to the second to n-th layer being applied.

4. The method according to claim 1, wherein
the respective layer to be applied is continuously applied, melted on the underside and bonded to the layer beneath it.

5. The method according to claim 1, wherein
the base body consists of a material selected from the group consisting of polypropylene, a processed wood material and a composite material.

6. The method according to claim 1, wherein,
a roller is used to generate the pressure, the movement of same following the respective contour of the base body.

7. The method according to claim 1, wherein
the respective thickness of the layers is in the range of ≦4 mm, preferably ≦2 mm.

8. The method according to claim 1, wherein
at least one of the layers is colored, structured and/or imprinted.

9. The method according to claim 1, wherein
the created multilayer arrangement overlaps or projects beyond given sections of the base body.

10. The method according to claim 1, wherein
the base body exhibits the form of a panel having peripheral, even contoured narrow ends, whereby the layer sequence is successively applied on at least one of the narrow ends.

11. The method according to claim 1, wherein
the base body consists of one lightweight panel comprising an upper panel, a lower panel, an intermediate structure and a lateral support edge, wherein the layer sequence is successively deposited in the edge region both on the exposed areas of the upper and lower panels as well as on the support edge.

12. The method according to claim 1, wherein
the underside melting process is pyrometrically monitored.

13. The method according to claim 1, wherein
the underside melting occurs immediately prior to the respective layers being brought into contact.

14. The method according to claim 1, wherein
the multilayer arrangement is formed into a multi-dimensional molded body by milling, notching, sanding or other such mechanical processing.

15. The method according to claim 14, wherein
the molded body is configured as an element selected from the group consisting of a handle element, a latching pin, a latching groove, a beveled surface, a decorative contour, and a tooth configuration.

16. The method according to claim 1, wherein,
the multilayer arrangement forms an ornamental element in the case of differently colored layers by regions of said layers being selectively ablated.

17. The method according to claim 1, wherein
its use when applying edging strips to processed wood material, wherein the multilayer arrangement is used instead of conventional edging strips.

18. The method according to claim 1, wherein
inserts are introduced after application of n-layers of a multilayer arrangement by selectively ablating regions of the layers, wherein the inserts are in particular metallic strip conductors or illuminants which are provided with a partly transparent finished edge in a subsequent step and thus form a functional ornamental element.

19. The method according to claim 18, wherein
the lengthwise layer-forming strips are composed of hard-soft sections, wherein the two sections for example serve in subsequently realizing electrical connector sockets.

20. The method according to claim 1, wherein
the layer-forming strips are positioned on a panel with a large one-sided overhang, wherein the overhang yields a peripheral parapet.

21. A multilayer arrangement produced in accordance with a method according to claim 1.

22. A multilayer arrangement according to claim 21 in the form of a furniture panel having an edging strip, wherein the edging strip is partially or fully materially bonded to the edge of the furniture panel.

23. A furniture panel having an edging strip in accordance with claim 22, wherein
the material of the furniture panel is selected from the group consisting of wood, processed wood material, wood substitute material, plastic, metal, glass, stone, and ceramic.
